(19) United States
(12) Patent Application Publication
(10) Pub. No.: US 2014/0367260 A1
(43) Pub. Date: Dec. 18, 2014

(54) Method and Apparatus for Identifying Objects in a Plurality of Objects Using Dielectrophoresis

(71) Applicants: Samuel J. Dickerson, Pittsburgh, PA (US); Donald M. Chiarulli, Pittsburgh, PA (US); Steven P. Levitan, Pittsburgh, PA (US); Craig Carthel, Portland, OR (US); Stefano Coraluppi, Pittsburgh, PA (US)

(72) Inventors: Samuel J. Dickerson, Pittsburgh, PA (US); Donald M. Chiarulli, Pittsburgh, PA (US); Steven P. Levitan, Pittsburgh, PA (US); Craig Carthel, Portland, OR (US); Stefano Coraluppi, Pittsburgh, PA (US)

(73) Assignee: NANOPHORETICS LLC, Monroeville, PA (US)

(21) Appl. No.: 14/295,934

(22) Filed: Jun. 4, 2014

Related U.S. Application Data
(60) Provisional application No. 61/835,134, filed on Jun. 14, 2013.

(51) Int. Cl. G01N 27/447; G01N 27/453; B03C 5/00

(52) U.S. Cl. CPC G01N 27/44721; B03C 5/005; G01N 27/453
USPC 204/547; 204/643

(57) ABSTRACT

An apparatus for identifying objects in a plurality of objects includes a portion which applies dielectrophoresis to the plurality of objects. The apparatus includes a portion which tracks the plurality of objects' reaction to the dielectrophoresis over time and extracts visible features about the plurality objects being tracked. The apparatus includes a portion which automatically identifies the objects from the plurality of objects based on the objects' reaction to the dielectrophoresis over time and the visible features of the objects. A method for identifying objects in a plurality of objects. A dielectrophoresis cartridge.

### CROSS-REFERENCE TO RELATED APPLICATIONS

This application is related to U.S. provisional patent application Ser. No. 61/835,134 filed Jun. 14, 2013, incorporated by reference herein.

### FIELD OF THE INVENTION

The present invention is related to identifying an object in a plurality of objects automatically based on the use of dielectrophoresis. (As used herein, references to the “present invention” or “invention” relate to exemplary embodiments and not necessarily to every embodiment encompassed by the appended claims.) More specifically, the present invention is related to identifying an object in a plurality of objects automatically based on the use of dielectrophoresis where the object is identified from the plurality of objects based on the objects' reaction to the dielectrophoresis over time and the visible features of the object.

### BACKGROUND OF THE INVENTION

This section is intended to introduce the reader to various aspects of the art that may be related to various aspects of the present invention. The following discussion is intended to provide information to facilitate a better understanding of the present invention. Accordingly, it should be understood that statements in the following discussion are to be read in this light, and not as admissions of prior art.

In recent years, there has been growing interest in the use of dielectrophoresis as a means to characterize and identify cells. To date, this characterization has remained a manual process where observations of cells undergoing dielectrophoresis are made under a microscope and cell velocities are individually recorded. Such a laborious process becomes impractical once the cell population is large, as is the case with the cell and bacteria samples used in medical diagnostics and has prevented dielectrophoresis from being used in practical applications.

### BRIEF SUMMARY OF THE INVENTION

With the technology described herein, recent advancements made in the area of object tracking are leveraged to be able to automatically collect dielectrophoresis velocity data to overcome this problem. When combined with algorithms for statistically classifying the cell tracks, a unique platform is provided for rapidly identifying cell types in heterogeneous mixtures.

The present invention pertains to an apparatus for identifying an object in a plurality of objects. The apparatus comprises a portion which applies dielectrophoresis to the plurality of objects. The apparatus comprises a portion which tracks the plurality of objects' reaction to the dielectrophoresis over time and extracts visible features about the plurality of objects being tracked. The apparatus comprises a portion which automatically identifies the object from the plurality of objects based on the object's reaction to the dielectrophoresis over time and the visible features of the objects.

The present invention pertains to a method for identifying an object in a plurality of objects. The method comprises the steps of applying dielectrophoresis to the plurality of objects. There is the step of tracking the plurality of objects' reaction to the dielectrophoresis over time and extracting visible features about the plurality objects being tracked. There is the step of automatically identifying the objects from the plurality of objects based on the object's reaction to the dielectrophoresis over time and the visible features of the objects.

### BRIEF DESCRIPTION OF THE SEVERAL VIEWS OF THE DRAWING

In the accompanying drawings, the preferred embodiment of the invention and preferred methods of practicing the invention are illustrated in which:

FIG. 1A is a block diagram showing the technologies associated with the claimed invention.

FIG. 1B is a block diagram of the apparatus of the present invention.

FIG. 2 shows Dielectrophoresis electrodes.

FIG. 3 shows an example concentric shell model that can be used to characterize the electrical features of cells.

FIG. 4 shows the real and imaginary parts of the Clausius-Mosotti factor for cells based on a multi-layer model and in a conductive medium.

FIG. 5 shows an example set of feature vectors from a hypothetical data-set for five particles.

FIG. 6 shows a cross-section of the electrodes of the cassette of the present invention.

FIG. 7 is an overhead view of a substrate.

FIG. 8 is a representation of the electrode array.

FIG. 9A is an exploded view of the cassette.

FIG. 9B is an overhead view of the cassette.

FIG. 10 is a block diagram showing the base station electronics.

FIG. 11A is a representation of the base station and the controller.

FIG. 11B is a block diagram of software functionality of the controller.

FIG. 12 is an overhead view of electrodes with particles where the electrodes are not activated.

FIG. 13 is an overhead view of electrodes with particles where the electrodes are activated.

### DETAILED DESCRIPTION OF THE INVENTION

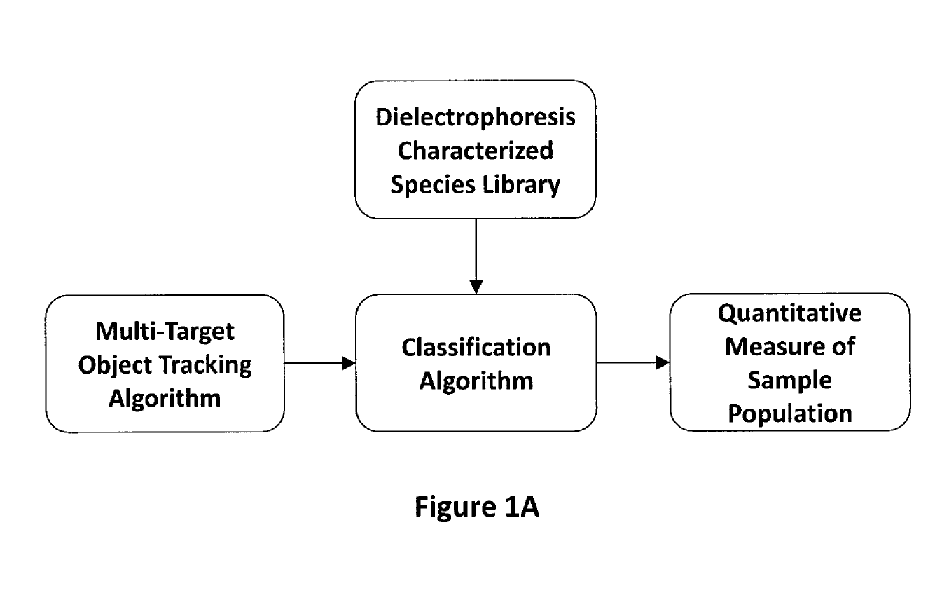

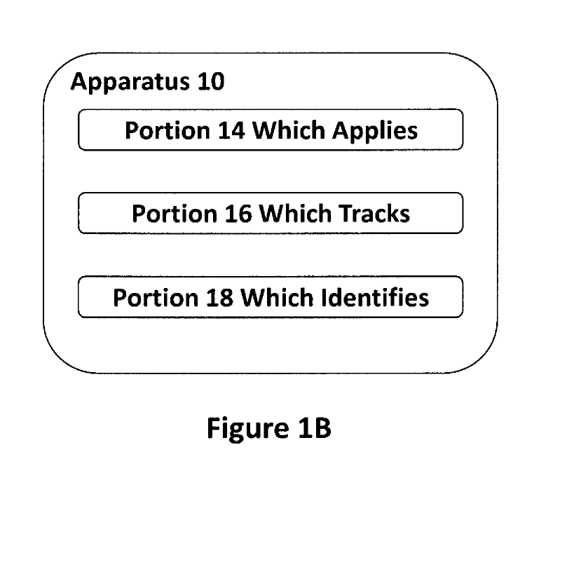

Referring now to the drawings wherein like reference numerals refer to similar or identical parts throughout the several views, and more specifically to FIG. 1B thereof, there is shown an apparatus 10 for identifying an object in a plurality of objects. The apparatus 10 comprises a portion 14 which applies dielectrophoresis to the plurality of objects. The apparatus 10 comprises a portion 16 which tracks the plurality of objects' reaction to the dielectrophoresis over time and extracts visible features about the plurality of objects 12 being tracked. The apparatus 10 comprises a portion 18 which automatically identifies the object 12 from the plurality of objects 12 based on the object's reaction to the dielectrophoresis over time and the visible features of the objects 12.

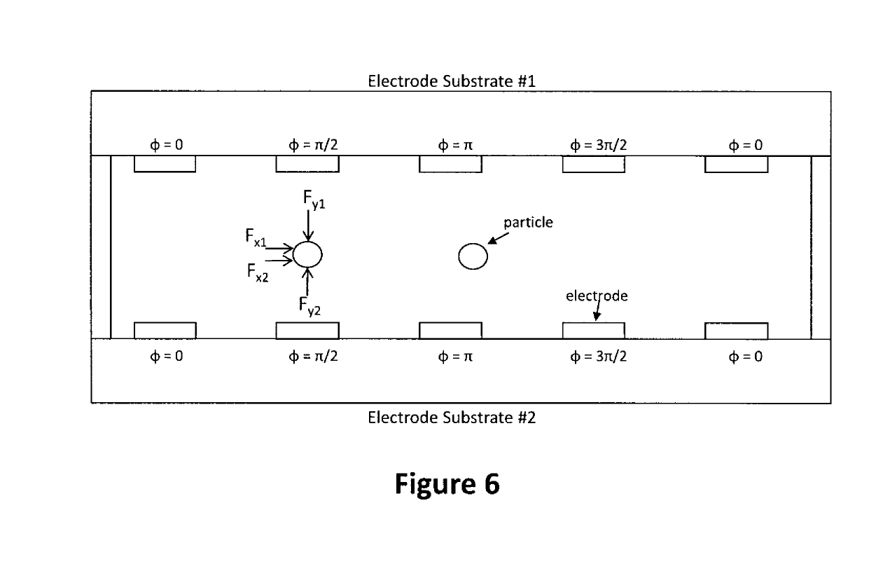

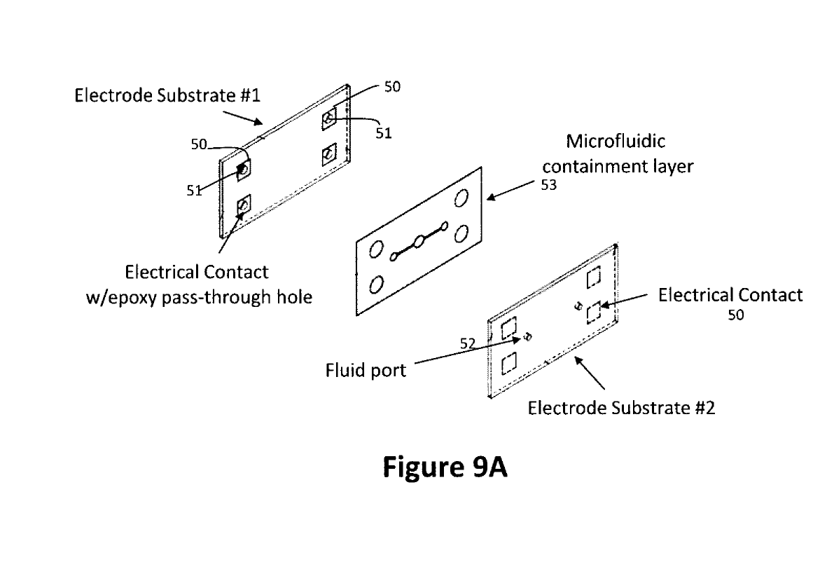

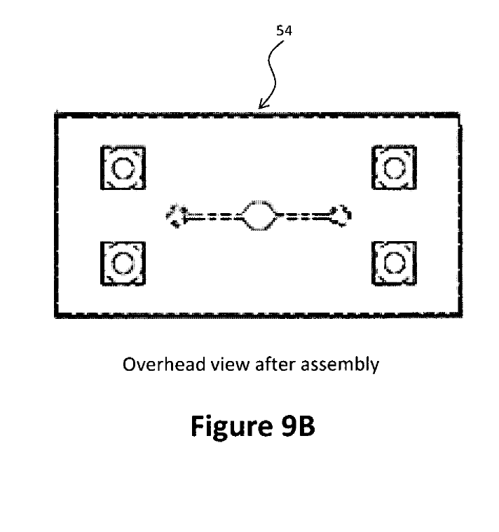

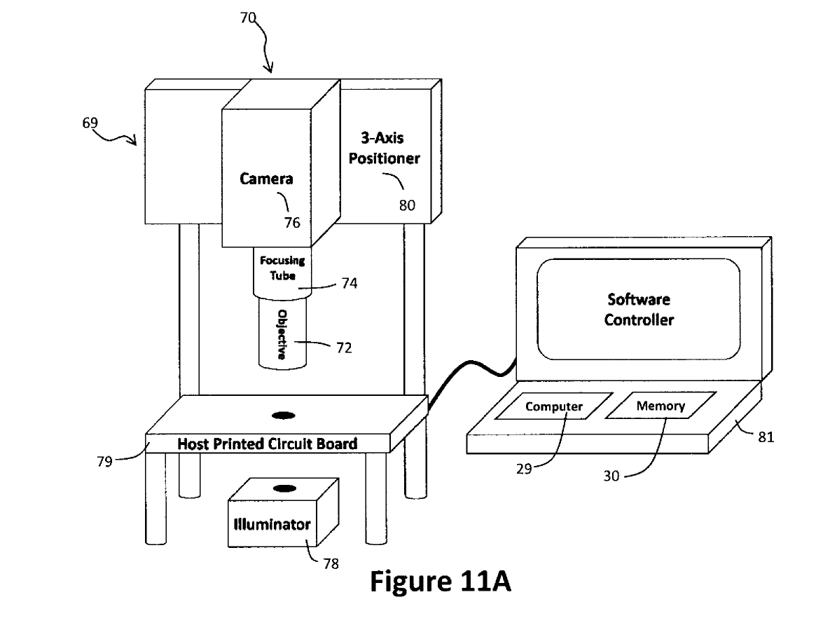

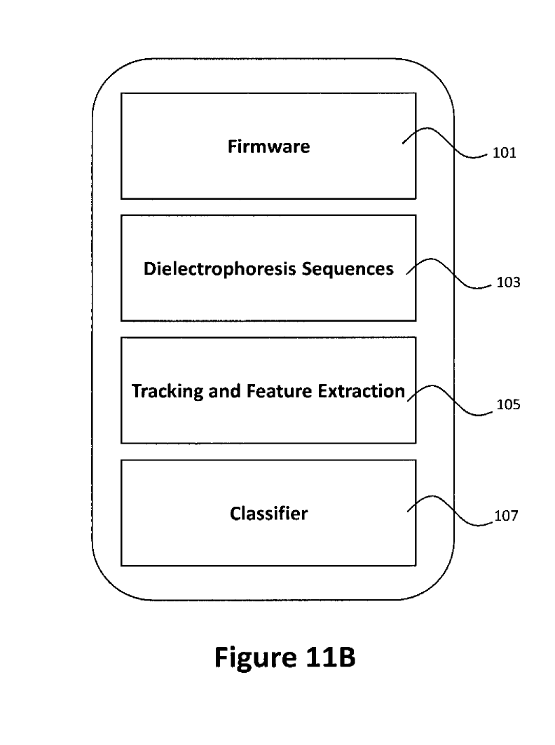

The portion 14 which applies may include a plurality of dielectrophoresis electrodes 20, as shown in FIG. 6. The portion 14 which applies may include a controller 24 which causes dielectrophoresis fields to be generated by the electrodes 20, as shown in FIG. 11A. The apparatus 10 may include a containment chamber 26 in which the objects 12 are disposed, as shown in FIG. 9A. The chamber 26 may have inlet and outlet ports 52 through which the objects 12 are delivered to or removed from the chamber 26. The portion 16 which tracks may include voltage sources 62 in communication with the controller 24 that drive the electrodes 20. The chamber 26 may be a sample cartridge 54.

Each electrode 20 may be connected to the voltage sources 62 via a programmable switching matrix 28 that allows for any electrode 20 to be connected to any of the voltage sources 62. The portion which tracks may include a memory 30 and an optical sub-system 70 which takes images of the objects 12 in the chamber 26 over time and stores the images in the memory 30. The optical sub-system 70 may include a microscope objective 72, focusing tube 74 and a camera 76.

The controller 24 may include a computer 29 programmed to use a multi-target tracking algorithm to track the objects 12 in the chamber 26. The tracking algorithm may be one that is an implementation of the multi-target multi-hypothesis tracking method. The controller 24 may cause the electrodes 20 to generate dielectrophoresis to induce motion in the objects 12. The type of dielectrophoresis used may include traveling-wave dielectrophoresis. The computer 29 may be programmed to use a statistical classification algorithm to determine a category or type in regard to the objects 12 based on the images of the objects 12. The statistical classification algorithm may include a general likelihood ratio test.

The present invention pertains to a method for identifying objects 12 in a plurality of objects 12. The method comprises the steps of applying dielectrophoresis to the plurality of objects 12. There is the step of tracking the plurality of objects' reaction to the dielectrophoresis over time and extracting visible features about the plurality of objects 12 being tracked. There is the step of automatically identifying the objects 12 from the plurality of objects 12 based on the objects' reaction to the dielectrophoresis over time and the visible features of the objects 12.

There may be the step of introducing the objects 12 into a chamber having dielectrophoresis electrodes 20. There may be the step of initiating a frequency sweep by a controller 24 of voltage sources 62 causing the objects 12 to move according to dielectrophoresis forces exerted on the objects 12 at each frequency.

There may be the step of capturing image frames of the objects' 12 motion during the frequency sweep with an optical imaging subsystem. There may be the step of processing the image frames by a computer of the controller 24 with tracking software stored in a memory 30 to record in the memory 30 trajectories of each object within the image frames at each time step during the frequency sweep. There may be the step of classifying the objects 12 based on the trajectories of the objects 12 from the images stored in the memory 30.

In the operation of the invention, the present invention is a novel methodology and accompanying hardware platform for rapid identification of micro and nano scale objects 12 or “particles”. Analyzed samples may contain particles that are biological in nature (e.g., cells, viruses, bacteria, etc.), particles that are non-biological (e.g., plastic, glass, etc.) or any mixture thereof in an aqueous sample. The approach here is based on the combination of three technologies (FIG. 1A): Dielectrophoresis, where electric fields are used to induce diverse motion in particle populations based on the electrical properties of each particle type. Multi-target tracking algorithms that can simultaneously track the motion of all particles in a sample and create a database of their trajectories and features, and classification algorithms that can classify the database based on learned motion characteristics for a particle type of interest. Together these three technologies provide a unique ability to identify specific particles (from a library of pre-characterized species). The existence of particular particle types (e.g., biological pathogens) can be identified using minute samples even when there are a relatively small number of particles of interest present in the sample. The time to process a sample can be just a few minutes, including the time for sample preparation, electrokinetic manipulation, image processing, tracking and identification.

In the first step of the technique, a sample containing particles is exposed to a sequence of dielectrophoresis fields specifically selected to differentiate the target particle type. While undergoing dielectrophoresis, each particle type reacts differently to a given field and has a unique velocity profile based on its internal structure, size, shape, and electrical characteristics. Therefore, with a general knowledge of these parameters for a given particle type, electric field frequencies are selected at which particles will be responsive to dielectrophoresis, as further explained below.

Next, a machine vision system is used to observe the reactions of the bacteria in the sample to the dielectrophoresis fields and their motion is tracked in real time using multi-target tracking software 105. This tracking software 105 generates a database of the motion of each particle along with its size, shape, and orientation, collectively known as features.

In the final step, this database is analyzed using a statistical classification algorithm 107 that compares the feature set of each particle with previously recorded and learned features for a bacteria type of interest. If particles exist in the sample with features that are statistically similar to the learned features, they are identified as the target bacteria. This technique provides a unique ability to identify specific bacteria without the need for culturing and population amplification and fluorescent labels not needed to observe the unique motion patterns. Since classification is based on a library of pre-characterized bacterial species, the platform is thus generalizable to many types of biological and non-biological particles. Sample handling and processing for the platform is simple and straightforward. Specimens can be swabbed, transferred to an aqueous transport medium and then delivered into the sample cartridge 54. Since the field configurations are driven by software, the technology uses one dielectrophoresis cartridge 54 design that is suitable for analyzing many different types of particles.

Dielectrophoresis Particle Manipulator

The first key technology is dielectrophoresis, a technique where electric fields can be used to differentiate particles based on their inherent electrical properties. The use of dielectrophoresis was first reported by Pohl in [1]. These electrical properties reflect differences not just in particle mass and volume, but they also capture subtle variations in the internal composition and morphology of the particle. Depending on the field characteristics, particles with variations in composition and morphology can be made to experience different amounts of force, forces in opposite directions, or no force at all. Using this effect we can simultaneously induce diverse motion in large numbers of particles across a sample in which the direction and velocity of each particle can be directly mapped to particle composition and morphology.

Dielectrophoresis is unique among electrokinetic techniques in that it operates on neutral particles with no net charge. Thus it can be used on a large class of inert and biological particles ranging from whole cells to viruses. When an electrically neutral particle is placed in the presence of a spatially non-uniform electric field, the particle becomes polarized. The force on the polarized particle is the product of its effective dipole moment, which is a function of the electrical properties of the particle in comparison to the medium, the particle radius, r, and the electric field gradient.

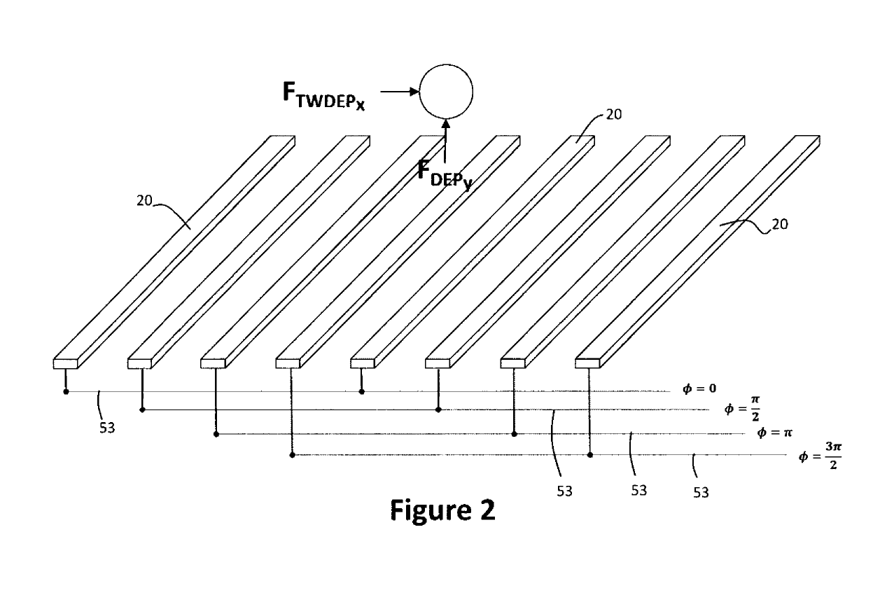

There are many forms of dielectrophoresis. The form of dielectrophoresis employed here (although not limited to) is Traveling Wave dielectrophoresis (TWDEP). With traveling wave dielectrophoresis the AC electric field is spatially non-uniform in both amplitude and phase. Typically, traveling-wave configurations employ a linear electrode 20 array 22, as shown in FIG. 2. There are no hard requirements on the width of the individual electrodes 20 used. However, in order for dielectrophoresis to operate, the gap spacing between electrodes 20 must be ‘significantly greater’ than the diameter of the particle being manipulated. Some specific examples (but not limited to) are yeast cells (with average diameter on the order of 6 um) can be manipulated with electrode gaps on the order of 10 um-15 um and up. HSV capsids (with average diameter on the order of 60 nm, can be manipulated with electrode gaps on the order of 150 nm and up. As the radius of the particle decreases, so does the amount of force exerted on that particle. Therefore, a reduction in particle size can be compensated for by either increasing the voltage magnitude or decreasing the electrode gap spacing (thereby increasing the field strength).

In this case, the electrodes 20 are driven by AC voltage signals, with each electrode 20 having a constant shift in phase with respect to its neighbor. In the example of FIG. 2, each electrode 20 along the array 22 is phase shifted by 90 degrees. This causes the magnitude of the electric field to be uniform along the lateral x-axis. In addition, because of symmetry, the magnitude of the electric field along the z-axis (parallel to the electrodes 20) is constant, therefore ∇Eₓ²=∇E_{z}²=0. Similarly, the phase of the field about the y and z axes is constant, thus ∇φ_{y}²=∇φ_{z}²=0. Therefore the time-averaged force exerted on the particle reduces to:

(\vec{F}_{DEP})=2πεₘr³[Re(K_{CM})∇E_{y}²+Im(K_{CM})Eₓ²∇φₓ]

From this expression, it can be seen that the traveling-wave dielectrophoresis force vector consists of a y-component that levitates the particle vertically with strength proportional to the magnitude gradient of the field and a horizontal force that moves the particle along the x-axis with strength proportional to the product of the electric field intensity and the gradient of the phase of the field. The strength of the force on a particle at any particular AC field frequency depends on a ratio of the complex permittivity of the particle to the complex permittivity of the buffer medium. This ratio is called the Clausius-Mossotti factor (K_{CM}). It is expressed as:

$${K}_{CM} = \frac{{ɛ}_{p}^{*} - {ɛ}_{m}^{*}}{{ɛ}_{p}^{*} + 2 {ɛ}_{m}^{*}}$$

where ε*ₘ and ε*ₚ are are the permittivity of the medium and particle respectively and are a function of the frequency of the electric field.

The Clausius-Mossotti factor, K_{cm}, is the key to the selective manipulation capabilities of dielectrophoresis. Both the real and imaginary parts of the complex K_{cm} are important. The real part acts as a proportionality constant to the vertical component of force exerted on the particle (DEP), while the imaginary part acts on the lateral force component (TWDEP). The appeal of dielectrophoresis in this methodology is that the direction and magnitude of the force exerted on a particle can be controlled externally by certain electric field parameters and the forces can be targeted towards a particle of a particular type. This high level of contactless yet specific control is possible because the inherent electrical characteristics of particles are based on their makeup. The electrical properties of particles not only reflect differences in their size and structure, but also capture subtle variations in their internal composition. Particles of different types have dissimilar electrical conductivities and permittivities that result in unique frequency/phase dependencies. These dependencies translate into distinct responses when introduced into an AC electric field. Previous attempts to characterize these frequency-dependent behaviors typically involve observation of particles dielectrophoretically induced velocities using a microscope and manual collection of data, as was reported by Huang [2].

The electrical features of the particle are characterized using a concentric shell model to model its effective complex permittivity, which in turn determines the Clausius-Mossotti factor. In the shell model, particles are electrically modeled as concentric spheres of varying thickness, each layer having unique values for electrical conductivity and permittivity. In this model, the effective permittivity of the particle can be approximated by successively combining expressions for each shell to pairs of layers that make up the complete model. While the multi-shell model is simplistic from a biological perspective, it is accurate enough to predict the forces exerted on particles and their resulting motion in fluids.

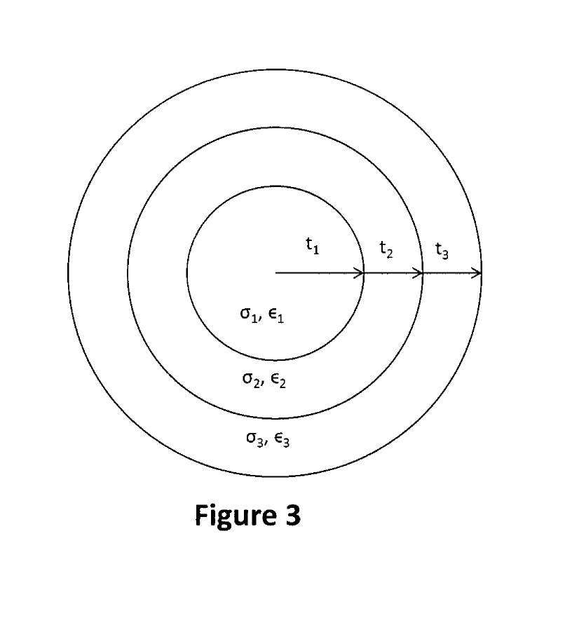

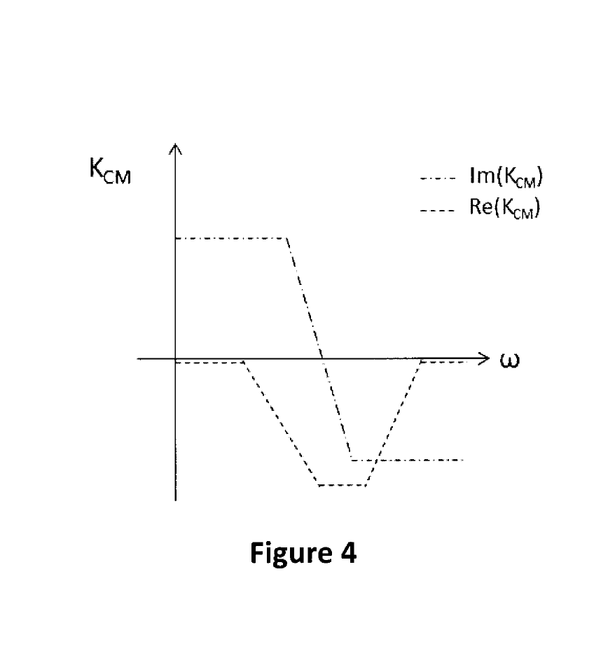

FIG. 3 shows an example concentric shell model that can be used to characterize the electrical features of cells. FIG. 4 shows the real and imaginary parts of the Clausius-Mosotti factor for cells based on a multi-layer model and in a conductive medium. The model reveals that cells will exhibit various modes of motion based on frequency. At very low frequencies, the negative real force component (Re(K_{CM})<0) exerted on the cells will cause them to levitate, with little to no lateral movement (Im(K_{CM})<0). As frequency increases, the particles will transition into a region where negative forces continue to elevate it, and but strong TWDEP force components will push the particle along the direction of the positive phase gradient. In the next band of frequencies where Re(K_{CM}) is positive, strong positive DEP forces will pull the particles down towards the electrode 20 edges. Eventually at high frequencies, when Re(K_{CM}) goes back to being negative, the cells will once again levitate and move laterally due to TWDEP forces. However, since the sign of Im(K_{CM}) is negative in this region, the particles will move in a direction opposite to the phase gradient.

In practice, the real (DEP) and imaginary (TWDEP) force components can be measured indirectly by configuring a known electric field and observing the particle's velocity. In order to extract the unique responses of the particles within the population, observations of particle motion are sampled over frequency band that ranges between the DC and the frequency at which the high frequency steady state response is observed. For this technology the extraction of this data takes place automatically by way of advanced multi-target tracking algorithms as the field generator frequency parameter is varied.

Multi-Target Multi-Hypothesis Object Tracker 105

Simultaneously tracking the trajectories of multiple objects 12 (e.g. thousands of bacterial cells moving under the influence of dielectrophoresis) is a difficult, computationally intensive problem to solve and is currently the subject matter of much research for defense surveillance applications. Multi-target tracking (MTT) algorithms are fundamentally different from single-target algorithms in that they must be able to accommodate cases in which there may be an unknown number of targets, targets that are closely spaced together and targets having paths that cross over one another. This presents a data association problem in which one is given a sequence of sets of track measurements, and must determine which measurements to associate with which targets and which to discard.

Multiple-hypothesis tracking (MHT) is generally acknowledged as the most powerful currently-known paradigm for multi-target tracking. It was first formalized in what is now referred to as hypothesis-oriented form. Unfortunately, the hypothesis-oriented methodology typically leads to an unmanageable number of hypotheses even for small problems. The track-oriented MHT approach was developed in the 1980s by researchers at ALPHATECH. Large-scale track-oriented MHT problems often require distributed, multi-stage solutions. For a sequence of sets of contacts Z^{k}=(Z₁, . . . , Zₖ), one wishes to estimate the state history X^{k} for all objects 12 present in the surveillance region that exist over the time sequence (t₁, . . . , tₖ) given the auxiliary discrete state history q^{k} that represents a full interpretation of all contact data: which contacts are false, how the object-originated ones are to be associated, and when objects 12 are born and die. Of interest here is the probability distribution p(X^{k}|Z^{k}) for object state histories given data. This quantity can be obtained by conditioning over all possible auxiliary states histories q^{k}.

$$p ( {X}^{k} \vert {Z}^{k} ) = {\sum }_{{q}^{k}} p ( {X}^{k} \vert {Z}^{k} , {q}^{k} ) p ( {q}^{k} \vert {Z}^{k} ) . \qquad ( 1 )$$

The MHT approach seeks to identify the MAP estimate for the auxiliary state history q^{k}, and identify the corresponding MMSE estimate for the object state history X^{k} conditioned on the estimate for q^{k},

$$\begin{matrix}{\hat{q}}^{k} = arg {max}_{{q}^{k}} p ( {q}^{k} \vert {Z}^{k} ) & ( 2 ) \\ \hat{X} = {\hat{X}}_{MMSE} ( {Z}^{k} , {\hat{q}}^{k} ) & ( 3 )\end{matrix}$$

Track-oriented MHT avoids enumeration of all global hypotheses q^{k}, though these are implicitly defined in the set of track hypotheses trees. With the track-oriented approach, there is selected a set of leaves that identify the MAP solution (2), with the feasibility constraint that all measurements are utilized at most once.

In practice, computational requirements preclude optimal, batch MHT solutions. For practical MHT solutions, a number of computation simplifications are adopted that include the following:

Only objects 12 that have been detected are included in the determination of tracks.

The maximum number of possible hypotheses is limited by disallowing unlikely associations between tracks and objects 12.

The tree data structure used to represent the candidate hypotheses for an object's track is pruned to a single global hypothesis with a fixed delay by eliminating the least likely tracks for that object.

Extraction of the track associated with an object is performed traversing the nodes of the pruned tree using logic-based or statistical tests.

One of the primary advantages of this tracking algorithm is that it does not require all of the possible global hypotheses for an object to be enumerated, thereby making it computationally-efficient.

Coraluppi and Carthel [3] have adapted multi-target tracking algorithms to particle tracking problems. For the dielectrophoresis application of interest here, the tracking solution is further modified by adding the following elements: (1) particle detection based on advanced image-segmentation technology; (2) feature-aided multi-target tracking where the augmented state space includes both target kinematics and detection-level features such as particle size.

In order to condition the recorded tracks, used as input to the classifier, the tracks are filtered using a Kalman smoothing filter. While it is known that track smoothing does not improve data-association performance, it does improve the input for downstream statistical particle classification algorithms. Several versions of the Kalman smoother have been documented in the literature; these include the conceptually-simple forward-backward algorithm and the computationally-efficient Rauch-Tung-Striebel smoother. The Kalman smoother provides the optimal trajectory by reasoning over all measurements in the past as well as the future. Like the Kalman filter, the Kalman smoother relies on a statistical object dynamical model and sensor measurement model; no further assumptions are invoked. The Kalman smoother provides the optimal trajectory by reasoning over all measurements in the past as well as the future. Like the Kalman filter, the Kalman smoother relies on a statistical object dynamical model and sensor measurement model; no further assumptions are invoked.

Statistical Object Classifier 107

In this step of the process, motion tracking and image data for each particle type will be analyzed using one or more algorithms from the general class of “classification” algorithms. Examples may include, but are not limited to, algorithms for statistical classification, linear classifiers, support vector machines, quadratic classifiers, decision trees, supervised machine learning, unsupervised machine learning, or clustering. The outcome of this analysis will be a measurement of the statistical similarity between the tracking and image data for each particle observation from the sample and previously analyzed and stored image and tracking information corresponding to one or more specific particles types of interest when exposed to the same or a similar dielectrophoresis field. Based on the computed level of statistical similarity, the system will determine if particles of the previously analyzed and stored types are present or not present in the sample.

The encoding of specific characteristics for particle motion tracking and image data particle type (known and unknown) will be recorded as a set of “features”. Features may include, but are not be limited to:
1. Morphological data such as size, shape and color of the particle
2. Exterior texture or surface features of the particle
3. Preferred orientation, rotational direction, and/or rotational speed induced on the particle when exposed to specific dielectrophoresis fields
4. Translational motion characteristics including velocity and acceleration, measured and recorded and three dimensions.

Track classification will be based on analysis of kinematic and feature characteristics of individual tracks, with prior knowledge of the characteristics of all particle types of interest. Sample characterization will be based on aggregation of track classification information. It is important to note that the actual dielectrophoresis field configuration parameters are not explicitly encoded in the feature set. Instead, training data sets for a given cell type are obtained by exposing samples of known composition to a predefined sequence of fields. Subsequently, trajectories from an arbitrary mixture of cell types are scored with respect to each calibrated type.

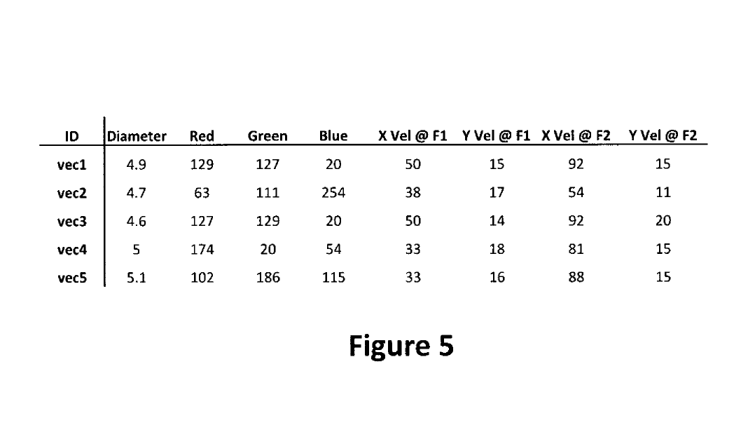

FIG. 5 shows an example set of feature vectors from a hypothetical data-set for five particles. In general, there could be hundreds or thousands of particles in each data-set. Here each vector represents the measurements extracted by the image processing and tracking software. Diameter, color (in three primary channels) and X and Y velocity response is shown for two frequencies for five particles. By observation it can be seen that particle 1 and 3 are mostly of the same type since they are very similar for most of their parameter values. For real data sets there are many more particles with more parameters and more variations. Therefore statistical classification methods such as those listed above will be used to perform “best matching” to pre-characterized particle types. Thus the presence and population of various particle populations in a heterogeneous mixture can be identified.

More generally, the specific algorithm currently employed to statistically classify tracks is the generalized likelihood ratio test (GLRT). The calibration used equations are:

$$\begin{matrix}{μ}_{i , j} = \frac{1}{N} {\sum }_{{N}_{tracks}} {X}_{s} & ( 4 ) \\ {\sum }_{i , j}^{2} = \frac{1}{N - 1} {\sum }_{{N}_{tracks}} {( {X}_{s} - {μ}_{i , j} )}^{2} & ( 5 )\end{matrix}$$

First, the hypothesis (Hᵢ) that best explains the observations is generated by determining what the maximum-likelihood cell type is for each cell track. Then, the probability of that hypothesis is tested against the null hypothesis (H₀), that the tracking data could be better explained as resulting from a general type referred to as ‘other’, a type for which there is no corresponding model or training data available. H₀ must be sufficiently distinct from Hᵢ in order to reasonably determine the cell type. A bounding region is introduced around Hᵢ and the restriction Σ>Σₘᵢₙ is maintained so as to avoid degeneracy, as more likely hypotheses corresponding to type ‘other’ can always be generated.

p(z|Hᵢ)=N(z; μᵢ, Σᵢ) (6)

p(z|H₀)=max_{μ⊂U}_{ₜ}_{[μ}_{ᵢ}_{-Δμ}_{ᵢ}_{+Δ], Σ>Σ}_{ₘᵢₙ}(N(z; μ, Σ)) (7)

Classification based on comparisons to calibrated training data, versus solely on models, is advantageous in real-world experimental settings where there are difficult to predict, but deterministic, factors to contend with such as AC electroosmosis and unknown medium conductivities. These factors cause significant deviations from model predictions. An additional advantage of GLRT in this application is that it provides accurate results without prior knowledge of the distribution of cell types in the mixture, which is precisely the parameter wished to be determined.

Apparatus Implementation

There are three major components used to realize the technology: a cartridge 54 that holds the dielectrophoresis electrodes 20 and microfluidics that deliver the sample, a configurable base station unit that contains electronics to generate the dielectrophoresis fields and capture images of the sample under test, and a collection of software modules to handle particle tracking and identification of targeted particles.

Sample Cartridges 54

The electrode 20 arrangement used to exert dielectrophoresis forces is similar to the traveling-wave dielectrophoresis electrodes 20 shown in FIG. 2. The electrodes 20 are arranged into a linear array 22 of equally spaced conductors. The electrode 20 width and gap spacing is determined by the size of the particles being manipulated. The electrode 20 gap spacing must be larger than the particle.

In order to manufacture the sample cartridge 54, arrays of conductive electrodes 20 are photolithographically patterned on substrates. A design is employed in which traveling-wave dielectrophoresis electrodes 20 are positioned both above and below the object being manipulated (as shown in FIG. 6). The phase gradients of the top and bottom electrode 20 chips are made to be identical. The electrode 20 arrangement of FIG. 6, where electrodes 20 are positioned above and below the particles, has two effects that enhance particle manipulation:

1) It increases the amount of lateral force exerted on a particle in a given direction, as the particle now experiences dielectrophoretic forces from both chips (Fₓ₁ and Fₓ₂).

2) This arrangement uses dielectrophoresis to stably position particles in the middle of the sample containment region (with respect to the vertical axis), since the vertical components of force exerted by both chips (F_{y1} and F_{y2}) oppose each other.

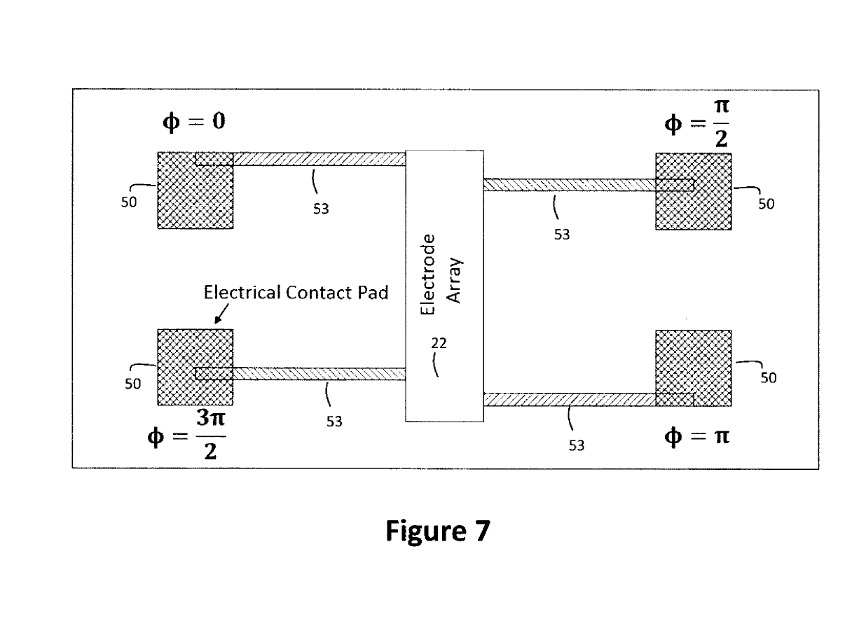

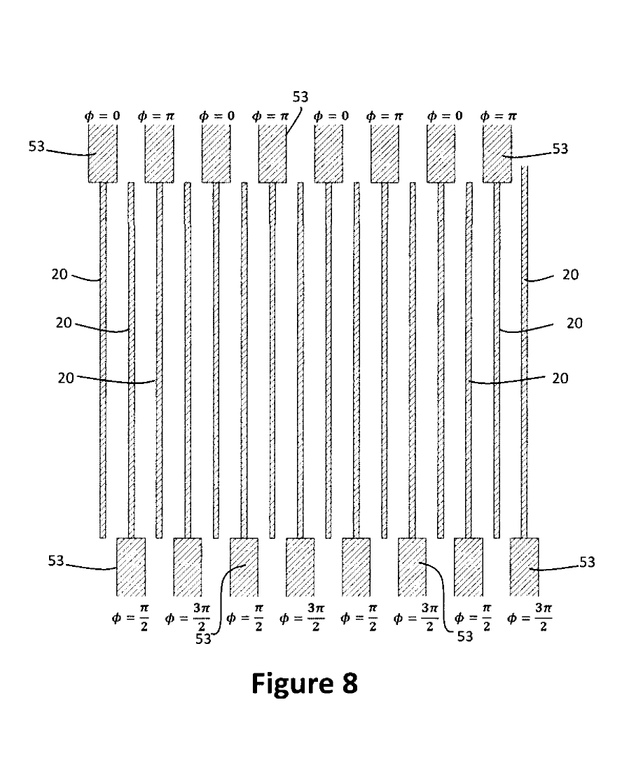

FIG. 7 shows an overhead view of the individual electrode 20 chips. Four electrical contact pads 50 are used to connect the electrodes 20 to four externally generated voltage signals. A two-layer metal process is used in the design so as to simplify the routing of electrodes 20, making the number of contact pads 50 necessary equal to the number of phases required (in this case four phases, four contact pads 50). A transparent substrate is used in fabrication so that the overhead view of the image capture portion is not obstructed during operation. The array 22 of dielectrophoresis electrodes 20 are contained in the center of the chip. Individual conductors as electrodes 20 are spaced at a fixed interval and connected in a repeating phase sequence, as shown by the zoomed in view of the electrode 20 array 22 in FIG. 8. The connections of the conductors 53 from the pads 50 to the electrodes 20 in the array 22 are depicted in FIG. 2.

FIG. 9a shows how the cartridge 54 is assembled after the fabrication step. Two electrode 20 chips are selected. One is designated as the bottom chip (electrode substrate #1 of FIG. 9a) and the other the top chip (electrode substrate #2 of FIG. 9a). The bottom chip 1 has holes 51 drilled through the center of each electrical contact pad 50. The top chip 2 has two holes drilled through the top of it that are specifically designated to serve as fluid inlet/outlet ports 52. These fluid ports 52 can be connected to tubing via syringes, thereby allowing for delivery of the sample containing particles to the region above the electrode array 22. Placed in between the top and bottom chip is a patterned layer 53 of thin film. This patterned layer 53 acts as a spacer between the top and bottom chips and creates a containment region for the fluidic sample. The thickness of this layer determines the depth of the sample chamber. The shape/pattern of the cutout in this layer determines the overall volume of the sample chamber and also allows fluid flow to be directed to the region in between the top and bottom dielectrophoresis electrodes 20. The three sample cartridge 54 components (top chip 2, fluid spacer 53 and bottom chip 1) are aligned and stacked on top of one another. In the final assembly step, an electrically conductive epoxy is filled into the electrical contact pad 53 holes of the bottom chip 1. This step creates an electrical connection between the contact pads 50 of the bottom chip 1 and the contact pads 50 of the top chip 2, ensuring that the voltage signals coming from the control electronics are driving the electrodes 20 on both chips. FIG. 9b shows the overhead view of the completed assembly.

Base Station 69

The base station is a bench top or a field portable device that contains the dielectrophoresis field electronics and the optics needed to capture images of the particle motion.

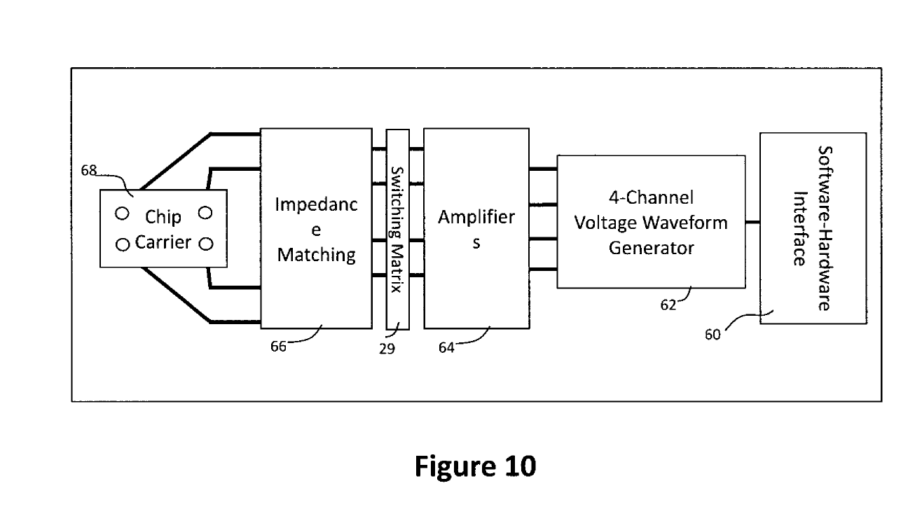

FIG. 10 shows a block diagram representation of the base station electronics. A software interface 60 is used to program the apparatus 10 and signal generation logic. A multi-channel voltage waveform generator 62, comprised of programmable logic and digital to analog converters, is used to generate voltage signals at the desired frequency and phase. The use of programmable logic in conjunction with digital to analog converters configuration allows for voltage waveforms of arbitrary shape, frequency and phase to be used as sources. The number of voltage channels required corresponds to the number of phases need (at least 2 phases/channels, typically 4 phases/channels). Next, the generated voltage waveforms are put through amplifiers 64 an amplification stage in order to set the appropriate voltage amplitude such that it can drive the electrode 20 array 22. After amplification, the voltage sources 62 are put through a stage of impedance matching electronics 66. The impedance matching stage is used to compensate for the uncertainty in the impedance of the electrode 20 array 22 once a fluidic sample has been injected into the cartridge 54. When the apparatus 10 is in use, the packaged sample cartridge 54 of FIGS. 9a and 9b is inserted into the chip carrier 68 of FIG. 10 that is mounted on the host printed circuit board 79. The carrier 68 makes a connection between the sample cartridge 54 electrical contact pads and the output channels of the impedance matching stage through the host printed circuit board 79. Inserting the chip into the carrier 68 also by extension connects the individual electrodes 20 within the sample cartridge 54 to the voltage signals generated by the control electronics, thereby enabling dielectrophoresis fields to be created in the region of the sample cartridge 54 where the particle sample is contained.

The optical sub-system 70 comprises three major parts: a microscope objective 72 72, focusing tube 74 and a camera 76. The optical sub-system 70 can be as simple as a fixed focus system that images an object that is exactly at the fixed working distance of the objective 72. A small CCD or CMOS imaging chip captures images of the particles in motion. The sample can be illuminated with an illuminator 78 from directly above or underneath using mirrors placed below the assembly. A 3-axis positioner 80 is used to make minor alignment and focusing adjustments. This low cost imaging solution not only makes the entire base station 69 portable, but also minimizes power consumption. The complete base station 69 is shown in FIG. 11a.

Software Modules

The software analysis modules will run on either an end-user computer laptop 81 or mobile device, depending on the computational capabilities required. The software modules, as shown in FIG. 11b, include: 1) firmware 101 for the sensor platform and a user interface, 2) specific field sequences 103 for the target particle, 3) tracking and feature extraction software 105, and 4) a classifier 107 trained for the target particle, all of which is stored in the memory 30 of the computer 81.

Use Case Scenario

An example of the use of the technology to identify the composition of a sample containing theoretical particle types, particles of ‘type A’ and ‘type B’ is now described.

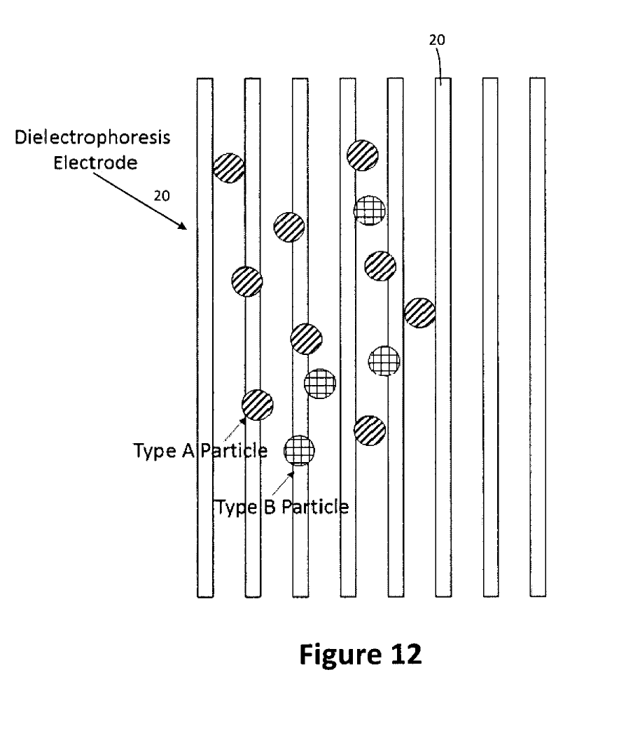

The user will first inject an aqueous sample containing particles into the sample cartridge 54. The cartridge 54 is placed into the base station 69 where contact between the electrodes 20 and voltage sources 62 are made and the cartridge 54 is aligned for imaging. Initially particles are at rest between the top and bottom electrodes 20 of the dielectrophoresis electrode array 22 and are located at arbitrary positions (FIG. 12).

The user, by way of software control, selects a targeted particle of interest. This selection initiates a frequency sweep of the voltage sources 62. The sweep starts at a specified minimum frequency and is increased until it reaches a specified maximum frequency. The number of the frequency steps between the minimum and maximum frequency, and the duration each frequency step is applied is determined by the performance of the tracker/classifier software and the granularity desired by the user. For example, for a sample containing a mixture of live and dead yeast cells, applying a sequence of dielectrophoresis fields that ranges from a minimum frequency of 10 kHz to a maximum frequency of 10 MHz and extracting velocity features at the sample frequencies of {1 kHz, 10 kHz, 50 kHz, 100 kHz, 200 kHz, 300 kHz, 400 kHz, 500 kHz, 750 kHz, 1 MHz, 2 MHz, 3 MHz, 4 MHz, 5 MHz, 10 MHz}, enough velocity features will have been recorded so as to be able to distinguish the two particle types and determine their relative concentration.

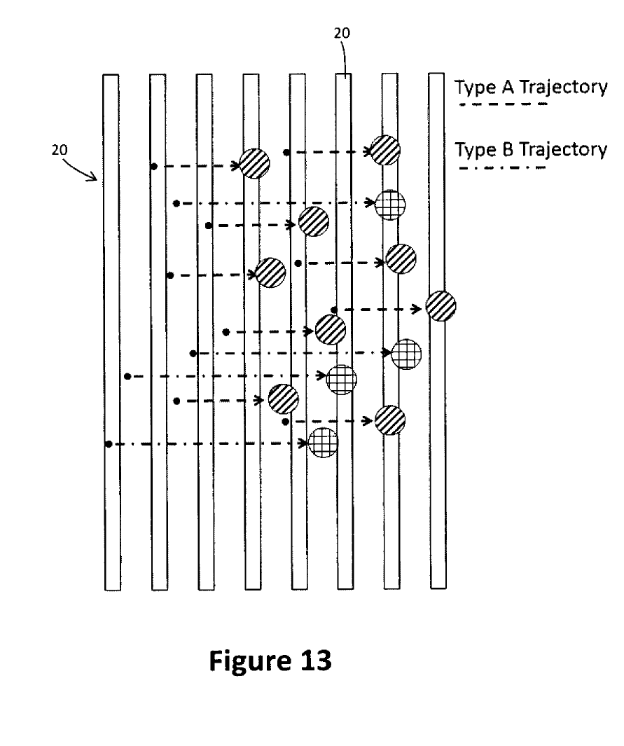

During the frequency sweep, the particles in the sample will move according to the dielectrophoresis forces exerted on them at that particular frequency. This motion is captured by the optical imaging sub-system 70 in the base station 69. The resulting image frames are processed by the tracking software and the trajectories of each particle within the field of view, at each time step during the frequency sweep is recorded. FIG. 13 depicts the results from multi-target tracking of the imaged sample on the hardware platform. It can be seen in this example, that while particles of type A and type B travel in the same lateral direction, particles of type B on average travel at a much higher speed than those of type A, and can allow the particle types to be distinguished from one another.

By the completion of the frequency sweep sequence, a large volume of statistics will have been gathered about the behavior of the sample population. These statistics (features) include both motion characteristics and observed physical properties such as size, shape, and color. The software classifier, trained to a library of observed velocity of known particle types, will classify this data based on its correspondence to the trained response. This classification will provide a present/not present indication for the particle type(s) of interest (in this case live and dead yeast cells) and their relative concentration in the sample. For example, live yeast cells in a 5 mS solution, under the influence of dielectrophoresis electrodes in a traveling wave configuration that have an electrode gap size of 15 um, and driven by voltages with amplitudes of 2 Vpp, will have approximate velocities of {10 um/s, 250 um/s, 500 um/s, 1000 um/s, 700 um/s, 600 um/s 500 um/s 400 um/s 300 um/s 200 um/s 100 um/s 10 um/s −10 um/s −100 um/s −200 um/s −300 um/s −500 um/s} at the sampling frequencies listed in [0098]. For that same configuration, and at those same sampling frequencies, dead yeast cells will have approximate velocities of {0 um/s, 0 um/s, 5 um/s, 10 um/s, 5 um/s, −10 um/s −15 um/s −20 um/s −25 um/s −50 um/s −75 um/s −100 um/s −150 um/s −175 um/s −150 um/s −100 um/s −55 um/s}, allowing the two types to and their relative concentrations to be determined.

References, all of which are incorporated by reference herein.

1. Pohl, Herbert A. “The Motion and Precipitation of Suspensoids in Divergent Electric Fields”, J. Appl. Phys. 22, 869, 1951.

2. Y Huang et al. “Differences in the AC electrodynamics of viable and non-viable yeast cells determined through combined dielectrophoresis and electrorotation studies.” Phys. Med. Biol., Vol 37, No 7 1992.

3. S. Coraluppi and C. Carthel, Modified Scoring in Multiple-Hypothesis Tracking, ISIF Journal of Advances in Information Fusion, vol. 7(2), pp. 153-164, December 2012.

4. C. Carthel and S. Coraluppi, Detection and Multiple-Hypothesis Tracking of Cells and Nuclei, IEEE International Symposium on Biomedical Imaging—Cell Tracking Challenge Workshop, San Francisco Calif., USA, April 2013.

5. C. Carthel and S. Coraluppi, Particle Tracking Workshop Methods and Results, IEEE International Symposium on Biomedical Imaging—Particle Tracking Challenge Workshop, Barcelona, Spain, May 2012.

Although the invention has been described in detail in the foregoing embodiments for the purpose of illustration, it is to be understood that such detail is solely for that purpose and that variations can be made therein by those skilled in the art without departing from the spirit and scope of the invention except as it may be described by the following claims.

1. An apparatus for identifying objects in a plurality of objects comprising:
a portion which applies dielectrophoresis to the plurality of objects;
a portion which tracks the plurality of objects' reaction to the dielectrophoresis over time and extracts visible features about the plurality objects being tracked; and
a portion which automatically identifies the objects from the plurality of objects based on the objects' reaction to the dielectrophoresis over time and the visible features of the objects.

2. The apparatus of claim 1 wherein the portion which applies includes a plurality of dielectrophoresis electrodes.

3. The apparatus of claim 2 wherein the portion which applies includes a controller which causes dielectrophoresis fields to be generated by the electrodes.

4. The apparatus of claim 3 including a containment chamber in which the objects are disposed.

5. The apparatus of claim 4 wherein the chamber has inlet and outlet ports through which the objects are delivered to or removed from the chamber.

6. The apparatus of claim 5 wherein the portion which tracks includes voltage sources in communication with the controller that drive the electrodes.

7. The apparatus of claim 6 wherein each electrode is connected to the voltage sources via a programmable switching matrix that allows for any electrode to be connected to any of the voltage sources.

8. The apparatus of claim 7 wherein the portion which tracks includes a memory and an optical sub-system which takes images of the objects in the chamber over time and stores the images in the memory.

9. The apparatus of claim 8 wherein the optical sub-system includes a microscope objective, focusing tube and a camera.

10. The apparatus of claim 9 wherein the controller includes a computer programmed to use a multi-target multi hypothesis tracking algorithm to check the objects in the chamber.

11. The apparatus of claim 10 wherein the controller causes the electrodes to generate traveling-wave dielectrophoresis to induce motion in the objects.

12. The apparatus of claim 11 wherein the computer is programmed to use a statistical classification algorithm to determine a category or type in regard to the objects based on the images of the objects.

13. The apparatus of claim 12 wherein the statistical classification algorithm includes a general likelihood ratio test.

14. A method for identifying objects in a plurality of objects comprising the steps of:
applying dielectrophoresis to the plurality of objects;
tracking the plurality of objects' reaction to the dielectrophoresis over time and extracting visible features about the plurality objects being tracked; and
automatically identifying the objects from the plurality of objects based on the objects' reaction to the dielectrophoresis over time and the visible features of the objects.

15. The method of claim 14 including the step of introducing the objects into a chamber having dielectrophoresis electrodes.

16. The method of claim 15 including the step of initiating a frequency sweep by a controller of voltage sources causing the objects to move according to dielectrophoresis forces exerted on the objects at each frequency.

17. The method of claim 16 including the step of capturing image frames of the objects' motion during the frequency sweep with an optical imaging sub-system.

18. The method of claim 17 including the step of processing the image frames by a computer of the controller with tracking software stored in a memory to record in the memory trajectories of each object within the image frames at each time step during the frequency sweep.

19. The method of claim 18 including the step of classifying the objects based on the trajectories of the objects from the images stored in the memory.

20. A dielectrophoresis cartridge for holding objects comprising:
a first substrate having dielectrophoresis electrodes;
a microfluidic containment layer in which the objects are disposed; and
a second substrate having dielectrophoresis electrodes, the layer disposed between the first and second substrates.

21. The cartridge of claim 19 wherein the second layer has inlet and outlet ports through which the objects are introduced to and removed from the layer.
